(19) United States
(12) Patent Application Publication
(10) Pub. No.: US 2024/0389625 A1
(43) Pub. Date: Nov. 28, 2024

(54) THICKENING PROMOTER FOR EGG SAUCE

(71) Applicant: FUJI OIL HOLDINGS INC., Osaka (JP)

(72) Inventor: Sho YAMASHITA, Ibaraki (JP)

(21) Appl. No.: 18/669,879

(22) Filed: May 21, 2024

(30) Foreign Application Priority Data
May 22, 2023 (JP) 2023-083912

(51) Int. Cl. A23L 15/00; A23L 29/238

(52) U.S. Cl. CPC A23L 15/20; A23L 29/238

(57) ABSTRACT

Provided is a thickening promoter for egg sauce, the thickening promoter containing a water-soluble polysaccharide having a viscosity of 200 mPa·s or less at 20° C. as 10 mass % aqueous solution. Also provided is a method for producing egg sauce employing the thickening promoter for egg sauce containing a water-soluble polysaccharide having a viscosity of 200 mPa·s or less at 20° C. as 10 mass % aqueous solution.

### CROSS-REFERENCE TO RELATED APPLICATION

This application claims priority from Japanese Patent Application No. 2023-083912 filed with the Japan Patent Office on May 22, 2023, the entire content of which is hereby incorporated by reference.

### BACKGROUND

### 1. Technical Field

The present disclosure relates to a thickening promoter for egg sauce.

### 2. Related Art

In recent years, egg processed products including liquid eggs that have been given flavor, viscosity, or the like have been used for various purposes.

For example, a sauce-like egg processed product with fluidity (hereinafter referred to as “egg sauce” in the present disclosure) is used for the purpose of enriching or thickening sauces used for cup yakisoba or teriyaki, fillings for hamburgers or rice balls, or mayonnaise or seasoning liquid. When using the egg sauce for these purposes, the egg sauce is preferably given an appropriate viscosity so as “to be easily entangled”, “not to seep out”, or “to thicken not to undergo syneresis”.

In general, a method using a thickener such as polysaccharide is known as a method of controlling physical properties of the egg processed product. For example, technology related to a method of adding glucomannan (WO 2011/033807), technology related to a method of producing egg fluid using whole egg fluid having a viscosity adjusted by adding a thickening polysaccharide such as xanthan gum (JP-A-H08-116925), and the like are known.

Further, a method of adding ethanol has also been proposed as a method that utilizes heat coagulation ability of eggs (JP-A-2019-187265).

### SUMMARY

The thickening promoter for egg sauce according to an embodiment of the present disclosure includes a water-soluble polysaccharide having a viscosity of 200 mPa·s or less at 20° C. as 10 mass % aqueous solution.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, when a thickener such as xanthan gum or glucomannan is used as in the technology of WO 2011/033807 or JP-A-H08-116925, viscosity of an egg sauce increases. Therefore, it is possible to obtain an effect of “being easily entangled with ingredients” or an effect of “thickening not to seep out”. However, physical properties caused by the thickener itself are significantly expressed. Therefore, there is a problem that original texture or flavor of egg is impaired. Further, in the technology of JP-A-2019-187265, flavor due to alcohol is felt due to ethanol used for thickening. Therefore, there has been a problem that in order to obtain a desired flavor, it was necessary to add more than a certain amount of sodium to create a strong flavor.

As described above, a satisfactory method for thickening the egg sauce without impairing the flavor and texture of the egg has not been established.

An object of the present disclosure is to provide a material that can thicken the egg sauce without impairing the flavor and texture of the egg.

As a result of intensive studies to solve the above problems, it has been found that a thickening promoter for egg sauce containing a water-soluble polysaccharide having a viscosity of 200 mPa·s or less at 20° C. as 10 mass % aqueous solution can thicken the egg sauce without impairing the flavor and texture of the egg. Thus, the thickening promoter for egg sauce of the present embodiment was completed.

That is, the present embodiment relates to the following thickening promoter for egg sauce and a method for producing the same, the egg sauce and a method for producing the same, a food product and a method for producing the same, and a method for promoting thickening of the egg sauce.
(1) A thickening promoter for egg sauce, the thickening promoter containing a water-soluble polysaccharide having a viscosity of 200 mPa·s or less at 20° C. as 10 mass % aqueous solution
(2) Egg sauce containing the thickening promoter for the egg sauce according to (1)
(3) A food product using the egg sauce according to (2)
(4) A method for producing egg sauce, the method including the following steps (A) to (C)
   a step (A) of preparing a water-soluble polysaccharide having a viscosity of 200 mPa·s or less at 20° C. as 10 mass % aqueous solution
   a step (B) of mixing the water-soluble polysaccharide and a raw material containing eggs
   a step (C) of heating a mixture obtained in the step (B)

However, in the step (B), 0.5 mass % or more and 250 mass % or less of the water-soluble polysaccharide is added based on protein of the eggs.
(5) The method for producing the egg sauce according to (4), in which heating temperature is below 95° C. in the step (C)
(6) A method for producing a food product using the egg sauce obtained by the method for producing the egg sauce according to (4) or (5)
(7) A method for promoting thickening of egg sauce, the method including the following steps of (a) to (c)
   a step (a) of preparing a water-soluble polysaccharide having a viscosity of 200 mPa·s or less at 20° C. as 10 mass % aqueous solution
   a step (b) of mixing the water-soluble polysaccharide and a raw material containing eggs
   a step (c) of heating a mixture obtained in the step (b)

However, in the step (b), 0.5 mass % or more and 250 mass % or less of the water-soluble polysaccharide is added based on protein of the eggs.
(8) The method for promoting the thickening of the egg sauce according to (7), in which heating temperature is below 95° C. in the step (C)

By using the thickening promoter for the egg sauce of the present embodiment, it is possible to thicken the egg sauce without impairing the flavor and texture of the egg.

### (Thickening Promoter for Egg Sauce)

The thickening promoter for the egg sauce of the present embodiment contains the water-soluble polysaccharide having a viscosity of 200 mPa·s or less at 20° C. as 10 mass % aqueous solution.

By adding the thickening promoter for the egg sauce of the present embodiment during production of the egg sauce, it is possible to obtain an egg sauce with good flavor while promoting the thickening of the egg sauce.

In the present embodiment, “promoting thickening” of the egg sauce means that the viscosity becomes higher (increases) than that of an egg sauce without additives. Preferably, in viscosity measurement described below, the viscosity of the egg sauce to which the water-soluble polysaccharide has been added is 110% or more relative to the viscosity of the egg sauce without additives, that is, viscosity increase rate is 110% or more.

Further, the thickening promoter for the egg sauce of the present embodiment can promote the thickening of the egg sauce without impairing the flavor and texture. In this regard, when another thickening polysaccharide is used, degree of thickening is lower than that of the egg sauce without additives, or even if thickened, the texture or flavor of the egg sauce deteriorates. That is, the thickening promoter for the egg sauce of the present embodiment is also excellent in terms of quality of the egg sauce.

Further, the temperature at which the thickening is promoted using the thickening promoter for the egg sauce of the present embodiment, that is, the heating temperature is preferably below 95° C., and more preferably 90° C. or less. The heating temperature can be 85° C. or lower, or 80° C. or lower. Further, a lower limit temperature is preferably 50° C. or higher, and more preferably 55° C. or higher. The lower limit temperature can also be 60° C. or higher, or 65° C. or higher.

Content of the water-soluble polysaccharide used in the thickening promoter for the egg sauce of the present embodiment in the thickening promoter for the egg sauce is preferably 50 mass % or more, and more preferably 60 mass % or more based on solid content. This content can be 70 mass % or more, 75 mass % or more, 80 mass % or more, 85 mass % or more, 90 mass % or more, 95 mass % or more, or 100 mass %.

The form of the thickening promoter for the egg sauce of the present embodiment is not limited. The thickening promoter for the egg sauce of the present embodiment can be used, for example, in the form of liquid, powder, or granule.

The thickening promoter for the egg sauce of the present embodiment can be appropriately used in combination with other additives within a range that does not impair its effects. Examples of the other additives include: monosaccharides including sugar, glucose, and fructose; oligosaccharides including sucrose, maltose, lactose, raffinose, maltotriose, trehalose, stachyose, and maltotetraose; sweeteners including sugar alcohol, high-fructose corn syrup, starch syrup, reduced starch syrup, oligosaccharide, reduced oligosaccharide, honey, sucralose, aspartame, and stevia; animal and vegetable oils including rapeseed oil, corn oil, cottonseed oil, safflower oil, olive oil, safflower oil, soybean oil, palm oil, fish oil, and egg yolk oil, or their refined oils (salad oils); edible fats and oils such as fats and oils obtained by chemical treatment, enzymatic treatment, or the like, including medium chain fatty acid triglyceride (MCT), diglyceride, hydrogenated oil, and interesterified oil; seasonings including salts, table salt, soy sauce, pepper, amino acid, calcium chloride, and nucleic acid; organic acids including acetic acid, citric acid, lactic acid, adipic acid, gluconic acid, tartaric acid, succinic acid, and malic acid; acidulants such as ascorbic acid; moist heat treated starch; modified starch; antioxidants such as vitamin E; and pigments.

### (Egg Sauce)

In the present embodiment, the egg sauce is a sauce-like food product or food material that contains eggs (whole eggs, egg yolks, or egg whites) and has fluidity. Preferably, the egg sauce contains mixed whole egg or egg yolk and various food ingredients.

Furthermore, as the eggs, cracked raw egg is used. In addition, any of various liquid eggs, sweetened liquid eggs, frozen eggs, powdered (dried) eggs, and the like can be used. One of these eggs can be used alone. Alternatively, two or more types of eggs may be appropriately mixed and used.

Examples of the other additives that can be added into the egg sauce of the present embodiment include: monosaccharides including sugar, glucose, and fructose; oligosaccharides including sucrose, maltose, lactose, raffinose, maltotriose, trehalose, stachyose, and maltotetraose; sweeteners including sugar alcohol, high-fructose corn syrup, starch syrup, reduced starch syrup, oligosaccharide, reduced oligosaccharide, honey, sucralose, aspartame, and stevia; animal and vegetable oils including rapeseed oil, corn oil, cottonseed oil, safflower oil, olive oil, safflower oil, soybean oil, palm oil, fish oil, and egg yolk oil, or their refined oils (salad oils); edible fats and oils such as fats and oils obtained by chemical treatment, enzymatic treatment, or the like, including medium chain fatty acid triglyceride (MCT), diglyceride, hydrogenated oil, and interesterified oil; seasonings including salts, table salt, soy sauce, pepper, amino acid, calcium chloride, and nucleic acid; organic acids including acetic acid, citric acid, lactic acid, adipic acid, gluconic acid, tartaric acid, succinic acid, and malic acid; acidulants such as ascorbic acid; moist heat treated starch; modified starch; antioxidants such as vitamin E; and pigments.

The egg sauce can be used in combination with another food product as appropriate. Examples of usage modes include pouring, coating, adding, mixing, or enclosing the egg sauce on various cooked foods or food materials. More specifically, the egg sauce can be used as a sauce for yakisoba or the like or as a sauce for teriyaki, as a sauce used for fillings for hamburgers, rice balls, or the like, as a sauce for adding richness to mayonnaise or seasoning liquid, as a sauce for oyakodon (bowl of rice with chicken and eggs) or katsudon (bowl of rice with pork cutlet), as a sauce used for thickening purposes, or the like.

### (Water-Soluble Polysaccharide)

Examples of the water-soluble polysaccharide of the present embodiment include water-soluble polysaccharides derived from leguminous plants including soybean, pea, adzuki bean, cowpea, kidney bean, fava bean, chickpea, lentil, and gum arabic, and pullulan. The water-soluble polysaccharide derived from leguminous plants is preferably water-soluble soybean polysaccharide, water-soluble pea polysaccharide, or gum arabic.

These water-soluble polysaccharides preferably have a viscosity of 180 mPa·s or less at 20° C. as 10 mass % aqueous solution. Further, these water-soluble polysaccharides preferably have a viscosity of 3 mPa·s or more, 4 mPa·s or more, 5 mPa·s or more, 8 mPa·s or more, or 10 mPa·s or more, at 20° C. as 10 mass % aqueous solution.

Two or more of these water-soluble polysaccharides can be used in combination.

Further, the water-soluble polysaccharide of the present embodiment has a viscosity of preferably 100 mPa·s or less, and more preferably 80 mPa·s or less at 20° C. as 10 mass % aqueous solution. The viscosity may be 70 mPa·s or less, 60 mPa·s or less, or 50 mPa·s or less. Examples of such water-soluble polysaccharides include the water-soluble soybean polysaccharide, the water-soluble pea polysaccharide, and the gum arabic.

Note that viscosity of the water-soluble polysaccharide is measured with a TVB-10 viscometer (manufactured by Toki Sangyo Co., Ltd., spindle No. M1 or M2, stirring speed 20, 60, 100 rpm).

### (Water-Soluble Soybean Polysaccharide)

The water-soluble soybean polysaccharide in the present embodiment refers to a water-soluble polysaccharide extracted from soybean seeds. The water-soluble soybean polysaccharide extracted from a fruiting part of the soybean seeds is preferred. More preferred is the water-soluble soybean polysaccharide extracted from okara produced as a by-product when producing, for example, tofu or isolated soybean protein. It is still more preferred to use okara obtained from defatted soybean. An example of a production method thereof is a method of extracting the water-soluble soybean polysaccharide from raw material okara under alkaline or weakly acidic conditions at a temperature above 100° C., preferably 150° C. or lower, and more preferably 130° C. or lower. The water-soluble soybean polysaccharide contained in an extraction solvent is obtained from a mixture of the extraction solvent and the raw material by solid-liquid separation. Examples of the trade name include “Soya Five-S” (produced by Fuji Oil Co., Ltd.).

### (Water-Soluble Pea Polysaccharide)

The water-soluble pea polysaccharide in the present embodiment refers to a water-soluble polysaccharide extracted from pea seeds. The water-soluble pea polysaccharide extracted from a fruiting part of the pea seeds is preferred. More preferred is the water-soluble pea polysaccharide extracted from yellow pea seeds. As a production method thereof, the water-soluble pea polysaccharide can be obtained, for example, by a production example described in the specification of WO 2012/176852. An example of the trade name is “FIPEA-D” (produced by Fuji Oil Co., Ltd.).

### (Method for Producing Egg Sauce)

The method for producing the egg sauce of the present embodiment will be described below by way of examples.

The egg sauce can be obtained by mixing the thickening promoter for the egg sauce containing a water-soluble polysaccharide with specific properties of the present embodiment with a raw material containing eggs and heating the mixture.

The thickening promoter for the egg sauce is added so that the water-soluble polysaccharide contained in the thickening promoter for the egg sauce is preferably 0.5 mass % to 250 mass % based on mass of the protein of the eggs.

A lower limit of addition amount can be more preferably 1 mass % or more, 1.5 mass % or more, 2 mass % or more, or 2.5 mass % or more based on the mass of the protein of the eggs.

Further, an upper limit of the addition amount can be more preferably 230 mass % or less, 200 mass % or less, 150 mass % or less, 100 mass % or less, 95 mass % or less, 90 mass % or less, 85 mass % or less, 80 mass % or less, 75 mass % or less, 70 mass % or less, 65 mass % or less, 60 mass % or less, 55 mass % or less, 50 mass % or less, 45 mass % or less, 40 mass % or less, 35 mass % or less, or 30 mass % or less.

Further, the heating temperature is preferably below 95° C., and more preferably 90° C. or less. The heating temperature can be 85° C. or lower. Further, the lower limit temperature is preferably 50° C. or higher, and more preferably 55° C. or higher. The lower limit temperature can be 60° C. or higher or 65° C. or higher.

Furthermore, a heating time is preferably 5 minutes or more, and more preferably 8 minutes or more. The heating time can also be 10 minutes or more, 12 minutes or more, or 15 minutes or more. Further, an upper limit of the heating time is preferably 120 minutes or less, and more preferably 100 minutes or less. The upper limit of the heating time can be 90 minutes or less, 80 minutes or less, or 70 minutes or less.

### Examples and Comparative Examples

The present embodiment will be described with reference to Examples and Comparative Examples below. Note that % in the examples means mass % unless otherwise specified.

In Examples and Comparative Examples, the water-soluble polysaccharides used as the thickening promoters for egg sauces are as follows.
Water-soluble soybean polysaccharide: “Soyafive-S-DA100” (produced by Fuji Oil Co., Ltd., viscosity of 10% aqueous solution: 40.0 mPa s)
Water-soluble pea polysaccharide: “FIPEA-D” (produced by Fuji Oil Co., Ltd., viscosity of 10% aqueous solution: 21.0 mPa·s)
Dextrin: “Maldek PH400P” (produced by Showa Sangyo Co., Ltd., viscosity of 10% aqueous solution: 2.6 mPa·s)
HM pectin: “GENU pectin type YM-115-LJ” (produced by Sansho Co., Ltd., viscosity of 10% aqueous solution: unmeasurable)
Gum Arabic: “Arabic Call SS” (produced by San-Ei Yakuhin Boeki Co., Ltd., viscosity of 10% aqueous solution: 12.2 mPa·s)
Pullulan: (produced by Hayashibara Co., Ltd., viscosity of 10% aqueous solution: 177.7 mPa·s)
Xanthan gum: “SATIAXANE CX91” (produced by Cargill Japan Ltd., viscosity of 10% aqueous solution: unmeasurable)

### (Test of Egg Sauce Using Egg Yolk)

Raw materials were mixed in formulations in Tables 1-1 and 1-2, and heated under heating conditions to obtain the egg sauces.

Note that the mixing was performed using a rotational viscometer (RheolabQC, Yamato Scientific Co., Ltd., coaxial cylinder type Peltier temperature control system, coaxial cylinder measurement system CC27/QC-LTD, and vane type measurement system (ST24-2D/2V/2V-30/109 (custom-made))) at a stirring speed of 100 rpm. The heating temperature was increased to a specified temperature (70° C.) over 10 minutes under the heating conditions. After the heating temperature reached the specified temperature, the specified temperature was maintained for 30 to 60 minutes.

Note that the above rotational viscometer was used to evaluate promotion of the thickening of the egg sauce using the egg yolk. After reaching the temperature of 70° C., viscosities were measured after heating periods of 30 to 60 minutes.

Note that a protein content of the egg yolk was 16.5%. The results are shown in Table 1-1 (Examples 1 to 4 and Comparative Examples 1 and 2) and Table 1-2 (Examples 5 to 8 and Comparative Examples 3 to 5).

Evaluation criteria in Tables 1-1 and 1-2 are as follows. Note that flavor evaluation and texture evaluation were performed by five panelists, and the evaluations were determined by consensus of the panelists.

### (Viscosity Evaluation)

A: Viscosity increase rate is 150% or more based on egg sauce without additives
B: Viscosity increase rate is 110% to 149% based on egg sauce without additives
C: Viscosity increase rate is 80% to 109% based on egg sauce without additives
D: Viscosity increase rate is 79% or less based on egg sauce without additives

### (Flavor Evaluation)

B: Flavor of egg sauce is good without any problems
D: Flavor of egg sauce is unnatural and poor

### (Texture Evaluation)

B: Texture is good with feeling of the same viscosity as when egg sauce without polysaccharide additives is heated
D: Texture is poor with feeling of viscosity different from when egg sauce without polysaccharide additives is heated

### (Comprehensive Evaluation)

A: Viscosity evaluation is A, flavor evaluation is B, and texture evaluation is B
B: Viscosity evaluation is B, flavor evaluation is B, and texture evaluation is B
D: At least one of viscosity evaluation, flavor evaluation, and texture evaluation is D, or viscosity evaluation is C and at least one of flavor evaluation and texture evaluation is D

When comprehensive evaluation was A or B, it was determined to be pass.

TABLE 1-1

| | Heating (70° C. × 30 min) | | | Heating (70° C. × 40 min) | | |
|---|---|---|---|---|---|---|
| | Comparative | | | Comparative | Comparative | Comparative |
| Formulation (%) | Example 1 | Example 1 | Example 2 | Example 2 | Example 3 | Example 4 |
| Egg yolk | 90.0 | 90.0 | 90.0 | 80.0 | 80.0 | 80.0 |
| Salt | — | — | — | — | — | — |
| Water-soluble soybean polysaccharide | — | 0.5 | 1.0 | — | 1.0 | 2.0 |
| Water | 10.0 | 9.5 | 9.0 | 20.0 | 19.0 | 18.0 |
| Total | 100 | 100 | 100 | 100 | 100 | 100 |
| Addition ratio of polysaccharides | — | 3.4 | 6.7 | — | 7.6 | 15.2 |
| to protein content of egg (%) | | | | | | |
| Viscosity (mPa · s) | 3593 | 5080 | 6672 | 2078 | 3961 | 7929 |
| Viscosity increase rate to no additive (%) | — | 141 | 186 | — | 191 | 382 |
| Viscosity evaluation | — | B | A | — | A | A |
| Flavor evaluation | B | B | B | B | B | B |
| Texture evaluation | B | B | B | B | B | B |
| Comprehensive evaluation | — | B | A | — | A | A |

TABLE 1-2

| | Heating (70° C. × 60 min) | | | | | | |
|---|---|---|---|---|---|---|---|
| | Comparative | Comparative | Comparative | | | | |
| Formulation (%) | Example 3 | Example 4 | Example 5 | Example 5 | Example 6 | Example 7 | Example 8 |
| Egg yolk | 90.0 | 80.0 | 70.0 | 90.0 | 80.0 | 80.0 | 70.0 |
| Salt | 2.0 | 2.0 | 2.0 | 2.0 | 2.0 | 2.0 | 2.0 |
| Water-soluble soybean polysaccharide | — | — | — | 0.5 | 0.5 | 1.0 | 2.5 |
| Water | 8.0 | 18.0 | 28.0 | 7.5 | 17.5 | 17.0 | 25.5 |
| Total | 100 | 100 | 100 | 100 | 100 | 100 | 100 |
| Addition ratio of polysaccharides | — | — | — | 3.4 | 3.8 | 7.6 | 21.6 |
| to protein content of egg (%) | | | | | | | |
| Viscosity (mPa · s) | 6911 | 4201 | 1451 | 10609 | 4707 | 5862 | 4913 |
| Viscosity increase rate to no additive (%) | — | — | — | 154 | 112 | 140 | 339 |
| Viscosity evaluation | — | — | — | A | B | B | A |
| Flavor evaluation | B | B | B | B | B | B | B |
| Texture evaluation | B | B | B | B | B | B | B |
| Comprehensive evaluation | — | — | — | A | B | B | A |

Viscosity increase rates of the egg sauces using egg yolks of Examples 1 to 8 were good. Further, the flavor was also good as the flavor of the egg sauce. Furthermore, the texture was also good, and the same viscosity as when the egg sauce without polysaccharide additives was heated was felt.

### (Test of Egg Sauce Using Whole Egg)

According to the formulations in Table 2, the raw materials were mixed in the same manner as in Example 1, and then heated under the heating conditions of 72° C. for 10 minutes to obtain the egg sauces. The results are shown in Table 2. Note that the rotational viscometer was used to evaluate the promotion of the thickening of the egg sauces using the whole eggs, as in the cases of the egg sauces using the egg yolks. After the heating temperature reached 72° C., the viscosity was measured after heating for 10 minutes. Note that the protein content of the whole egg was 12.2%.

The evaluation criteria in Table 2 are as follows. Note that the flavor and texture were evaluated by five panelists. The evaluations were determined by the consensus of the panelists.

### (Viscosity Evaluation)

A: Viscosity increase rate is 200% or more based on egg sauce without additives
B: Viscosity increase rate is 120% to 199% based on egg sauce without additives
C: Viscosity increase rate is 70% to 119% based on egg sauce without additives
D: Viscosity increase rate is 69% or less based on egg sauce without additives

### (Flavor Evaluation)

B: Flavor of egg sauce is good without any problems
D: Flavor of egg sauce is unnatural and poor

### (Texture Evaluation)

B: Texture is good with feeling of the same viscosity as when egg sauce without polysaccharide additives is heated
D: Texture is poor with feeling of viscosity different from when egg sauce without polysaccharide additives is heated

### (Comprehensive Evaluation)

A: Viscosity evaluation is A and flavor evaluation is B
B: Viscosity evaluation is B and flavor evaluation is B
D: At least one of viscosity evaluation, flavor evaluation, and texture evaluation is D, or viscosity evaluation is C and at least one of flavor evaluation and texture evaluation is D

When the comprehensive evaluation was A or B, it was determined to be pass.

TABLE 2

| | Heating (72° C. × 10 min) | | |
|---|---|---|---|
| | Comparative | Example | Example |
| Formulation (%) | Example 6 | 9 | 10 |
| Whole egg | 60.0 | 60.0 | 60.0 |
| Water-soluble soybean | — | 1.0 | 2.0 |
| polysaccharide | | | |
| Water | 40.0 | 39.0 | 38.0 |
| Total | 100 | 100 | 100 |
| Addition ratio of polysaccharides | — | 13.7 | 27.3 |
| to protein content of egg (%) | | | |
| Viscosity (mPa · s) | 32 | 59 | 154 |
| Viscosity increase rate | — | 184 | 481 |
| to no additive (%) | | | |
| Viscosity evaluation | — | B | A |
| Flavor evaluation | B | B | B |
| Texture evaluation | B | B | B |
| Comprehensive evaluation | — | B | A |

The viscosity increase rates of the egg sauces using the whole eggs in Examples 9 and 10 were good. Further, the flavor was also good as the flavor of the egg sauce. Furthermore, the texture was also good, and the same viscosity as when the egg sauce without polysaccharide additives was heated was felt.

### (Test of Egg Sauce Using Egg White)

According to the formulations in Table 3, the raw materials were mixed using a magnetic stirrer (octagon rotor: 38 mm×f8 mm) to obtain the egg sauces. A packaging material (material: polyethylene, polyamide, inner dimensions 15.5 cm×11 cm) was filled with 200 g of the egg sauce. The filled packaging material was heated under the heating conditions of 62° C. for 10 minutes or 57° C. for 10 minutes while completely immersed in hot water. Thereafter, the filled packaging material was cooled to 20° C. using ice water.

A TVB-10 viscometer (manufactured by Toki Sangyo Co., Ltd.) was used to evaluate the promotion of the thickening of the egg sauces using the egg whites. The viscosity was measured under conditions of Spindle No. M2 and the stirring speed of 20 rpm (20° C.). The results are shown in Table 3. Note that the protein content of the whole egg was 12.2%.

The evaluation criteria in Table 3 are as follows. The flavor and texture were evaluated by five panelists. The evaluations were determined by the consensus of the panelists.

### (Viscosity Evaluation)

A: Viscosity increase rate is 150% or more based on egg sauce without additives
B: Viscosity increase rate is 110% to 149% based on egg sauce without additives
C: Viscosity increase rate is 80% to 109% based on egg sauce without additives
D: Viscosity increase rate is 79% or less based on egg sauce without additives

### (Flavor Evaluation)

B: Flavor of egg sauce is good without any problems
D: Flavor of egg sauce is unnatural and poor

### (Texture Evaluation)

B: Texture is good with feeling of the same viscosity as when egg sauce without polysaccharide additives is heated
D: Texture is poor with feeling of viscosity different from when egg sauce without polysaccharide additives is heated

### (Comprehensive Evaluation)

A: Viscosity evaluation is A and flavor evaluation is B
B: Viscosity evaluation is B and flavor evaluation is B
D: At least one of viscosity evaluation, flavor evaluation, and texture evaluation is D, or viscosity evaluation is C and at least one of flavor evaluation and texture evaluation is D

When the comprehensive evaluation was A or B, it was determined to be pass.

TABLE 3

| | Heating | | Heating | |
|---|---|---|---|---|
| | (57° C. × 60 min) | | (62° C. × 20 min) | |
| | Compar- | | Compar- | |
| | ative | Example | ative | Example |
| Formulation (%) | Example 7 | 11 | Example 8 | 12 |
| Whole egg | 90.0 | 90.0 | 90.0 | 90.0 |
| Water-soluble soybean | — | 0.5 | — | 0.5 |
| polysaccharide | | | | |
| Water | 10.0 | 9.5 | 10.0 | 9.5 |
| Total | 100 | 100 | 100 | 100 |
| Addition ratio of | — | 5.5 | — | 5.5 |
| polysaccharides to | | | | |
| protein content of | | | | |
| egg (%) | | | | |
| Viscosity (mPa · s) | 1486 | 1764 | 223 | 285 |
| Viscosity increase rate | — | 118.7 | — | 127.8 |
| to no additive (%) | | | | |
| Viscosity evaluation | — | B | — | B |
| Flavor evaluation | B | B | B | B |
| Texture evaluation | B | B | B | B |
| Comprehensive | — | B | — | B |
| evaluation | | | | |

The viscosity increase rates of the egg sauces using the egg whites in Examples 11 and 12 were good. Further, the flavor was also good as the flavor of the egg sauce. Furthermore, the texture was also good, and the same viscosity as when the egg sauce without polysaccharide additives was heated was felt.

### (Examination 1 of Various Polysaccharides)

According to the formulations in Table 4, the raw materials were mixed in the same manner as in Example 1, and then heated under the heating conditions to obtain the egg sauces. The results are shown in Table 4. The evaluation criteria were the same as in Example 9.

Note that in Examples, the viscosity was measured after heating at 70° C. for 15 minutes and after heating at 70° C. for 40 minutes. When viscosity evaluations were different from each other, worse evaluation was adopted. For example, when a sample heated at 70° C. for 10 minutes was evaluated as “B” and a sample heated at 70° C. for 40 minutes was evaluated as “C”, the Example or the Comparative Example was evaluated as “C”.

TABLE 4

| | | Comparative | Example | Example | Example | Example | Example | Example | Example |
|---|---|---|---|---|---|---|---|---|---|
| Formulation (%) | | Example 9 | 13 | 14 | 15 | 16 | 17 | 18 | 19 |
| Whole egg | | 90.0 | 90.0 | 90.0 | 90.0 | 90.0 | 90.0 | 90.0 | 90.0 |
| Water-soluble soybean polysaccharide | | — | 0.3 | 0.5 | 1.0 | — | — | — | — |
| Water-soluble pea polysaccharide | | — | — | — | — | 1.0 | — | — | — |
| Gum arabic | | — | — | — | — | — | 1.0 | — | — |
| Pullulan | | — | — | — | — | — | — | 0.5 | 1.0 |
| Water | | 10.0 | 9.7 | 9.5 | 9.0 | 9.0 | 9.0 | 9.5 | 9.0 |
| Total | | 100 | 100 | 100 | 100 | 100 | 100 | 100 | 100 |
| Addition ratio of polysaccharides | | — | 2.7 | 4.6 | 9.1 | 9.1 | 9.1 | 4.6 | 9.1 |
| to protein content of egg (%) | | | | | | | | | |
| Before heating | Viscosity (mPa · s) | 35 | 30 | 28 | 31 | 35 | 28 | 57 | 49 |
| 70° C. × 15 min | Viscosity (mPa · s) | 73 | 94 | 71 | 119 | 130 | 78 | 153 | 469 |
| | Viscosity increase rate | 207 | 313 | 254 | 384 | 372 | 279 | 271 | 959 |
| | by heating (%) | | | | | | | | |
| | Viscosity increase rate | — | 151 | 122 | 185 | 180 | 134 | 131 | 463 |
| | to no additive (%) | | | | | | | | |
| 70° C. × 40 min | Viscosity (mPa · s) | 633 | 821 | 882 | 1351 | 1019 | 871 | 1280 | 1575 |
| | Viscosity increase rate | 1809 | 2737 | 3150 | 4358 | 2911 | 3111 | 2265 | 3221 |
| | by heating (%) | | | | | | | | |
| | — | — | 151 | 174 | 241 | 161 | 172 | 125 | 178 |

| | | | | | | | | |
|---|---|---|---|---|---|---|---|---|
| Viscosity evaluation | — | B | B | A | A | B | B | A |
| Flavor evaluation | B | B | B | B | B | B | B | B |
| Texture evaluation | B | B | B | B | B | B | B | B |
| Comprehensive evaluation | — | B | B | A | A | B | B | A |

Results showing good viscosity increase rate of the egg sauce using the whole egg were also obtained from the water-soluble pea polysaccharide, the gum arabic, and the pullulan as polysaccharides other than the water-soluble soybean polysaccharide. Further, the flavor was also good as the flavor of the egg sauce. Furthermore, the texture was also good, and the same viscosity as when the egg sauce without polysaccharide additives was heated was felt.

### (Examination 2 of Various Polysaccharides)

According to the formulations in Table 5, the raw materials were mixed in the same manner as in Example 1, and then heated under the heating conditions to obtain the egg sauces. The results are shown in Table 5. The evaluation criteria were the same as in Example 13.

TABLE 5

| | | Comparative | Comparative | Comparative | Comparative | Comparative | Comparative | Comparative |
|---|---|---|---|---|---|---|---|---|
| Formulation (%) | | Example 9 | Example 10 | Example 11 | Example 12 | Example 13 | Example 14 | Example 15 |
| Whole egg | | 90.0 | 90.0 | 90.0 | 90.0 | 90.0 | 90.0 | 90.0 |
| Dextrin | | — | 1.0 | — | — | — | — | — |
| HM pectin | | — | — | 0.1 | 1.0 | — | — | — |
| Ethanol | | — | — | — | — | 1.0 | — | — |
| Xanthan gum | | — | — | — | — | — | 0.02 | 0.1 |
| Rapeseed oil | | — | — | — | — | — | 0.06 | 0.3 |
| Water | | 10.0 | 9.0 | 9.9 | 9.0 | 9.0 | 9.92 | 9.6 |
| Total | | 100 | 100 | 100 | 100 | 100 | 100 | 100 |
| Addition ratio of polysaccharides | | — | 9.1 | 0.9 | 9.1 | 9.1 | 0.2 | 0.9 |
| to protein content of egg (%) | | | | | | | | |
| Before heating | Viscosity (mPa · s) | 35 | 33 | 55 | 137 | 34 | 39 | 97 |
| 70° C. × 15 min | Viscosity (mPa · s) | 73 | 57 | 105 | 598 | 1438 | 71 | 119 |
| | Viscosity increase rate | 207 | 173 | 192 | 436 | 4229 | 183 | 122 |
| | by heating (%) | | | | | | | |
| | Viscosity increase rate | — | 83 | 93 | 211 | 2042 | 88 | 59 |
| | to no additive (%) | | | | | | | |
| 70° C. × 40 min | Viscosity (mPa · s) | 633 | 670 | 767 | 1600 | coagulated | 614 | 530 |
| | Viscosity increase rate | 1809 | 2030 | 1396 | 1168 | — | 1579 | 546 |
| | by heating (%) | | | | | | | |
| | Viscosity increase rate | — | 112 | 77 | 65 | — | 87 | 30 |
| | to no additive (%) | | | | | | | |

| | | | | | | | |
|---|---|---|---|---|---|---|---|
| Viscosity evaluation | — | C | C | D | A | C | D |
| Flavor evaluation | B | D | D | D | D | D | D |
| Texture evaluation | B | B | D | D | B | D | D |
| Comprehensive evaluation | — | D | D | D | D | D | D |

Among the egg sauces using the whole eggs, Comparative Example 10 (dextrin), Comparative Examples 11 and 12 (HM pectin), and Comparative Examples 14 and 15 (xanthan gum) had poor viscosity increase rates of the egg sauces. Further, the flavor was not good.

Further, the texture in Comparative Example 10 was the same as when the egg sauce without polysaccharide additives was heated.

In Comparative Examples 11 and 12 and Comparative Examples 14 and 15, very sticky texture was obtained. This texture was poor, and the viscosity different from when the egg sauce without polysaccharide additives was heated was felt.

Furthermore, in Comparative Example 13 (ethanol), the texture was good but the flavor was poor.

### Comparative Example 16, Examples 20 and 21

An effect of thickening when the egg sauce was frozen and then thawed was examined.

According to the formulations in Table 6, the raw materials were mixed in the same manner as in Example 1, and then heated under the heating conditions to obtain the egg sauces. Each egg sauce was cooled to 20° C. Thereafter, the viscosity was measured using the rotational viscometer used in Example 1.

Further, each egg sauce was placed in a −20° C. freezer and frozen. After 20 days of freezing, the sample was thawed under running water, and then the viscosity at 20° C. was measured using the rotational viscometer. The results are shown in Table 6.

TABLE 6

| | | Comparative | | |
|---|---|---|---|---|
| Formulation (%) | | Example 16 | Example 20 | Example 21 |
| Egg yolk | | 85 | 85 | 85 |
| Salt | | 1 | 1 | 1 |
| Water-soluble soybean polysaccharide | | — | 0.5 | 1 |
| Water | | 14 | 13.5 | 13 |
| Addition ratio of polysaccharides to protein content of egg (%) | | — | 3.6 | 7.1 |
| 66° C. × 60 min heating | Viscosity (mPa · s) | 2050 | 7450 | 13490 |
| before freezing | Viscosity increase rate to no additive (%) | — | 363 | 658 |
| 68° C. × 60 min heating | Viscosity (mPa · s) | 48410 | 139500 | 1145000 |
| before freezing | Viscosity increase rate to no additive (%) | — | 288 | 2365 |
| 66° C. × 60 min heating | Viscosity (mPa · s) | 41270 | 119100 | 523600 |
| after freezing (D + 20) | Viscosity increase rate to no additive (%) | — | 289 | 1269 |
| 68° C. × 60 min heating | Viscosity (mPa · s) | 122400 | >1200000 | >1200000 |
| after freezing (D + 20) | Viscosity increase rate to no additive (%) | — | 980 or more | 980 or more |

| | | | |
|---|---|---|---|
| Viscosity evaluation | — | A | A |
| Flavor evaluation | B | B | B |
| Texture evaluation | B | B | B |
| Comprehensive evaluation | — | A | A |

In the frozen and thawed egg sauces of Examples 20 and 21, thickening was observed compared to the egg sauce without polysaccharide additives of Comparative Example 16. The viscosity evaluation was good. Further, the flavor evaluation and the texture evaluation were also good.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A thickening promoter for egg sauce, the thickening promoter comprising a water-soluble polysaccharide having a viscosity of 200 mPa·s or less at 20° C. as 10 mass % aqueous solution.

2. Egg sauce comprising the thickening promoter for the egg sauce according to claim 1.

3. A food product using the egg sauce according to claim 2.

4. A method for producing egg sauce, the method comprising:
a step (A) of preparing a water-soluble polysaccharide having a viscosity of 200 mPa·s or less at 20° C. as 10 mass % aqueous solution;
a step (B) of mixing the water-soluble polysaccharide and a raw material containing eggs; and
a step (C) of heating a mixture obtained in the step (B), wherein
in the step (B), 0.5 mass % or more and 250 mass % or less of the water-soluble polysaccharide is added based on protein of the eggs.

5. The method for producing the egg sauce according to claim 4, wherein heating temperature is below 95° C. in the step (C).

6. A method for producing a food product using the egg sauce obtained by the method for producing the egg sauce according to claim 4.

7. A method for promoting thickening of egg sauce, the method comprising:
a step (a) of preparing a water-soluble polysaccharide having a viscosity of 200 mPa·s or less at 20° C. as 10 mass % aqueous solution;
a step (b) of mixing the water-soluble polysaccharide and a raw material containing eggs; and
a step (c) of heating a mixture obtained in the step (b), wherein
in the step (b), 0.5 mass % or more and 250 mass % or less of the water-soluble polysaccharide is added based on protein of the eggs.

8. The method for promoting the thickening of the egg sauce according to claim 7, wherein heating temperature is below 95° C. in the step (c).
